(19) United States
(12) Patent Application Publication
(10) Pub. No.: US 2012/0085612 A1
(43) Pub. Date: Apr. 12, 2012

(54) VEHICLE PROPULSION ENERGY AND UTILITY POWER DELIVERY SYSTEM

(76) Inventor: Frédérick Churchill, Montreal (CA)

(21) Appl. No.: 13/202,729

(22) PCT Filed: Feb. 22, 2010
(86) PCT No.: PCT/CA2010/000257

§ 371 Date: Dec. 7, 2011

Related U.S. Application Data
(60) Provisional application No. 61/154,015, filed on Feb. 20, 2009.

(51) Int. Cl. B60M 1/02; E04B 1/343; H02J 3/00

(52) U.S. Cl. 191/33 R; 307/25; 52/64

(57) ABSTRACT

Designs introduced to three sectors that relate to the distribution network and support structures for delivering energy and utilities services to buildings, distributed renewable energy generation and its supply to electrical vehicles, and public transportation including roadway services and mass transportation infrastructure, including the application of aerially supported utilities whereby the implementation and distribution of utility and municipal services are now integrated with the objective of a more efficient installation, maintenance and operation. Disclosed is an aerial modular support system that can accommodate all categories of utility services whether handling fluids, solids, energy or digital signals. An electrified roadway power distribution for vehicles, an electrified train in a semi-continuous tunnel and a solar energy collector used to provide electricity and to protect roadways are also disclosed.

### FIELD OF THE INVENTION

This invention generally relates to utilities and roadways. More specifically, the invention relates to a vehicle propulsion energy and utility power delivery system, and provides the aerial delivery of utilities, wind and solar power generation systems, electrified roadways and the integrated implementation of these aforementioned services in a modular, expandable structure.

### BACKGROUND OF THE INVENTION

### Existing Problems

Almost all existing utility services have been built employing underground distribution networks. This includes drinking water, domestic sewers, rainwater sewers, fire water, natural gas and information and telephone cables. Electrical secondary power distribution has been installed using both wooden poles for stringing aerial cables and by using conduit for underground cables. However, most existing electrical aerial installations are under-designed and prone to ice storms and other types of severe weather.

Many utility companies have invested or plan to invest to bury these power lines. Not only are the existing systems under designed for extreme weather but the ugly wooden poles used as supports have a relatively short life span (40 years) and the wood preservatives used to protect against rot heavily contaminate the soil around the base of each pole. The installations are often eye sores and depreciate the value of the surrounding buildings.

Major traffic arteries are now regularly blocked to traffic to permit excavation of new utility lines or to repair existing service lines. In cities with a cold winter climate, the rupture of underground water mains in winter is now a common occurrence as the water lines have aged and frost penetration deepens under arteries with increased vehicle traffic. Drinking water lines now date well over 100 years and the materials used over this period of time were not considered as health hazards. Today it is well known that the lead and other heavy metals used in pipes and fittings represent serious health risks. The repair and replacement of these services in place is very expensive and full of inconvenience.

The looming environmental crisis arising from greenhouse gas emissions and the pollution of rivers, lakes and oceans is creating a need for new urban utility services designed to increase energy efficiency. This includes district heating and cooling, water recirculation and renewable energy distribution for both electricity and biogas. Also required, is a system to collect biodegradable waste for its use in the production of renewable biogas. Water shortages are now leading to rationing in states such as California. The senseless discharge of waste into the ocean is leading to a catastrophic failure of that eco-system. The situation is worsening daily.

The installation of new utility services using underground piping may make their implementation economically unfeasible. However, a convenient aerial structure will allow the installation of overhead pipes and cables to be completed and maintained at a more competitive cost to underground services.

Certain municipal services are presently provided to communities but in fact the approaches taken and their poor execution cause serious inconvenience and safety risks for residents. Snow removal on streets and sidewalks is costly and pedestrians, bicyclists and drivers have to contend with the risks and inconvenience of slippery and dangerous surfaces.

Mass transportation is costly and often unreliable and people wishing to use the bicycle as their principal means of transportation do so in risky and unpleasant conditions as the roadways belong to the vehicle traffic. Rain, snow, intense sunlight and high temperatures limit the use of the bicycle and walking as a convenient daily means of transportation.

The energy consumed for transportation by vehicle is now an important source of greenhouse gas emissions. If the vehicles propulsion systems are converted to renewable electricity, the energy required to produce the equipment to produce the electricity becomes also a source of emissions. It becomes important to reduce the energy consumption of all processes and systems and this independent of the fact that the energy used is renewable.

The resistance created between the wheel and the surface on which it is rolling influences the amount of energy required to rotate the wheel. The more uniform and smooth the road surface the lower the resistance. Existing road surfaces offer varying levels of road resistance. A concrete road surface requires less energy than an asphalt surface and as the asphalt ages and the surface weathers, becomes less smooth and as a result the resistance gradually increases.

A buffed concrete surface may require 3-5% less energy than a new asphalt surface. Jointed concrete is the most common finish and this is noisy as the joints act as small bumps in the road. As asphalt surfaces weather the surface becomes rougher, it cracks and heaves from water infiltration. This in turn increases the resistance between the wheel and the surface.

In general, the life span of an asphalt surface is 17 years, a concrete surface double that, or 34 years. Many of the highways in the United States were built in the 1960's and are in need of replacement.

It will be prohibitively expensive to replace the entire width of existing road surfaces with the sole objective of decreasing rolling resistance and providing a quieter ride. However beams having a width slightly larger than the tire can be inserted into the roadway and the wheels run on an extremely smooth and uniform surface. Thus a major improvement in terms of energy savings, tire wear, and even a reduction in the size of the tires used can be achieved without replacing the entire road surface.

Such inserted beams can supply an optimum surface to minimise energy rolling resistance and the upper surface in contact with the wheel can be regularly reconditioned in place to keep the rolling resistance as low as possible. The contact patch area of tires and the tire pressure can offer substantial energy savings. The contact patch area is the area of the tire in contact with the road. Smaller contact areas decrease rolling resistance as does higher air pressures. Besides decreasing rolling resistance the tires will make less noise, tire life will increase and coatings can be regularly applied to increase the adhesion between the tire and road surface. The savings in energy consumed, tires consumed and increased passenger comfort will be important.

The transportation sector and in particular the internal combustion engine is a large contributor to greenhouse gas emissions and air pollution. In densely populated urban areas the negative effect of air pollution on health and life expectancy is well documented. The energy necessary to advance a vehicle includes the energy necessary to run the motor, the road resistance and the wind resistance. An important decrease in the aforementioned energy requirements will result in a significant increase in system efficiency.

### SUMMARY OF THE INVENTION

This is a brief summary of innovative designs being introduced to three sectors that relate to:
the distribution network and support structures for delivering energy and utilities services to buildings,
distributed renewable energy generation and its supply to electrical vehicles,
public transportation including roadway services and mass transportation infrastructure.

Significant changes to the production and delivery infrastructure in the above mentioned sectors will significantly reduce the environmental footprint of society and greatly improve overall energy and operating efficiency of the systems involved.

According to the present invention, there is provided a vehicle propulsion energy and utility power delivery system with a modular structure, the modular structure being installable over a roadway and including a plurality of interconnectable modules, each of the interconnectable modules comprising:
a central platform member extending over the roadway;
two lateral support members on opposite sides of the central platform member; and
a vehicle propulsion energy and utility power distribution system positioned on the central platform member.

Preferably, the vehicle propulsion energy and utility power distribution system comprises a two phase electrical bus for distributing propulsion energy to vehicles operating under the central platform member through a friction type connection.

Preferably, at least one of the vehicles is a transportation chariot.

Preferably, the central platform member comprises adjacent groupings of solar panels and roofing panels positioned along a length of the central platform member, the solar panels and roofing panels providing overhead protection of the roadway against outdoor weather elements.

Preferably, the transportation chariot is a motorised chariot comprising an aerodynamic wind screen positioned on a front section of the chariot, and a vehicle accommodation subsystem adapted to carry at least one transportable vehicle for displacement of the at least one transportable vehicle along the roadway.

Preferably, each of the interconnectable modules further comprises a plurality of pipes and cables supported by the central platform member and connected to the vehicle propulsion energy and utility power distribution system for providing above-ground utility services for buildings proximate the roadway.

The first sector relevant to the present application is the application of aerially supported utilities whereby the implementation and distribution of utility and municipal services are now integrated with the objective of a more efficient installation, maintenance and operation. This implies a new and integrated approach to the support, the installation and the maintenance of the associated equipment, pipes and cables.

We intend to describe an aerial modular support system that can accommodate all categories of utility services whether handling fluids, solids, energy or digital signals. The existing systems were all planned and installed independently of one to another. Most services were installed underground and almost all aerially delivered services (example electricity distribution) were under designed for severe weather conditions.

The fact that both the utility and municipal services normally follow roadways provides an opportunity for creating synergy of operation between utility, municipal and transportation services. If the transportation system converts to renewable power generation and electric vehicles, transportation and electrical power generation systems can also incur synergy. As will be demonstrated, equipment installed to produce renewable solar energy will contribute to improved and safer roadways and sidewalks. Metallic structures installed to support piping for services such as district heating now also support the overhead power bars along roadways necessary to feed electric cars, trucks and buses.

Accordingly, the present invention provides a use of a roadway right-of-way for distributed renewable power generation and electrified roadway power distribution for vehicles, comprising:
two flat, electrically isolated surfaces running parallel to the road axis;
the surfaces are mounted aerially over the center of each traffic lane;
the surfaces are held in place on their back side to leave the surface facing the roadway unobstructed;
a telescopic connection rod extending up from the car;
two friction contact points at the end of the antenna rod that allows the points to remain in contact with the surface and displace in any direction over the face of the surfaces; and
an insulated cable to connect the two contact points to the vehicle motors and battery.

According to another aspect of the invention, there is also provided an electrified train in a semi-continuous tunnel comprising:
individually motorised chariots with rear access;
windscreen and walls around the chariot to minimise air resistance and this, for several standard sizes of vehicles;
preferably electric propulsion using motor wheels;
preferably maglev or air flotation technology for supporting the weight of the platform and its load; and
a three track system whereby one track is used to shunt or merge chariots while the train is in motion one of the two main lines. The merge is the middle lane and can merge chariots into either of the two main lines.

The invention also proposes a solar energy collector used to provide electricity and to protect roadways comprising a frame that holds multiple CSP (Concentrated Solar Production) modules and is suspended over a roadway right-of-way, the frame sitting on a modular, expansive structure that follows the roadway axis, wherein the CSP modules and frame create a continuous surface permitting that precipitation falling on the surface may be collected for reuse and that the precipitation does not reach the road surface.

According to another aspect of the invention, there is also provided a modular, expansive structure supported from a roadway or sidewalk right-of-way for integration of utility services, solar energy collection, and transportation services, comprising:
a plurality of utility, transport and municipal services supported on a series of vertical columns or poles that are placed parallel to the axis of a roadway;
columns placed on both sides of large roadways and opposite one another and with their foundations located on a roadway or sidewalk right-of-way, wherein the height of the first level of horizontal members is not lower than the clearance established for vehicles along the roadway;
the structure supporting horizontal power bars located over the centerline of each lane of traffic and these bars supply electricity to vehicles using the roadway;
if the structure includes a second level, the vertical columns support certain transportation services provided at this level including pedestrian walkways, bicycle paths, and light bus service;
the structure may support a protection over all or part of the roadway surface consisting of a frame containing CSP modules; and
the structure supports a utility raceway as defined in paragraph A.6 hereinbelow.

The invention also proposes a utilities distribution system using a utilities corridor supported by a modular, expansive, roadway structure, comprising:
a plurality of utility or municipal services supported aerially, parallel to one another and parallel to the axis of the roadway they follow,
wherein the utilities are supported by horizontal and vertical members that constitute a dedicated utilities corridor that is supported by a modular, expansive structure as defined in A.5 and wherein the utilities corridor may serve the buildings on one or both sides of the street.

According to another aspect of the invention, there is also provided a modular expansive surface beam for roadways comprising:
an existing roadway surface that is partially excavated to a width and height slightly larger than the beam dimensions;
a beam possessing a flat smooth surface slightly larger than the width of the tires of the vehicles is installed slightly higher than the nominal height of the road surface,
wherein the beam includes a middle rib section and lower under plate,
the under plate of the beam is attached to a pile cap below the road surface, and
adjusting bolts and a vibration pad are located on the top of the pile cap to adjust the height of the beam.

### BRIEF DESCRIPTION OF THE DRAWINGS

These and other objects and advantages of the invention will become apparent upon reading the detailed description and upon referring to the drawings in which:

FIG. 1 is a perspective view of a wind turbine installed over the median section of a divided highway right-of-way, the CSP modules cover only the median section and chariot train.

FIG. 2 is a perspective view of a wind turbine installed over the median section of a divided highway right-of-way, the CSP modules cover the median section and chariot train and the two traffic lanes on each side of the median.

FIG. 3 is a perspective view of an electric car on an electrified lane using a telescopic connecting rod.

FIG. 4 is a schematic view of an electric car connected to power bar by a telescopic connecting rod.

FIG. 5 is a side elevation view of two chariots travelling on an electrified track.

FIG. 6 is a rear view of chariots travelling in an electrified track with CSP modules installed over the chariot-train lanes but not over the traffic lanes.

FIG. 7 is an elevation view of CSP modules installed aerially to protect the entire roadway including vehicle traffic and chariot-trains.

FIG. 8 is an elevation view of a modular structure integrating, utilities, solar energy collection and transportation.

FIG. 9 is a front view of a vehicle propulsion energy and utility power delivery system in accordance with a preferred embodiment of the present invention.

FIG. 10 includes plan and elevation views of a utilities corridor installed on a modular structure over a roadway.

FIG. 11 is an end section view of modular road surface beams installed in a roadway.

FIG. 12 includes elevation and plan views of road surface beams installed in a roadway.

FIG. 13 is an elevation view of a modular structure for a divided highway.

FIG. 14 is an elevation view of a modular structure for an urban artery with two levels.

FIG. 15 is an elevation view of a modular structure for a residential street.

FIG. 16 is an elevation view of a modular structure for a rural road.

### LEGEND OF ITEMS IN FIGURES

1—commercial buildings
2—utilities corridor
3—aerial bicycle path
4—light aerial bus right-of-way
5—sidewalk right-of-way
6—parked electric vehicle and parking lane
7—moving electric vehicle and travel lane
8—aerial pedestrian walkway
9—vertical support column of structure
10—road surface
11—horizontal support member
12—CSP (Concentrated Solar Production) modules
13—roadway median
14—chariot travelling in a travel lane
15—chariot in a parallel merge lane
16—wind turbine platform
17—concrete leg for supporting wind turbine platform
21—aerial power bar consisting of two flat conducting surfaces that are electrically isolated. One being the power bar, the second the ground bar
22—flat conducting surface—ground
23—flat conducting surface—power
24—360 degree movement friction connections
25—underside conducting surface support attachments
26—telescopic power rod attached to vehicle on its center line
27—connecting cable between friction connections and motor/battery
30—frame for supporting utility services
31—a utility service application
32—utilities corridor
50—roadway right-of-way
51—wind turbine
60—vehicle wheel
61—road surface
62—road bed
63—pile (screw type)
64 beam height adjusting bolts
65—excavation of road surface
66—beam vertical support rib
67—hard smooth surface for the vehicle wheel
69—vibration pad

While the invention will be described in conjunction with example embodiment, it will be understood that it is not intended to limit the scope of the invention to such embodiment. On the contrary, it is intended to cover all alternatives, modifications and equivalents as may be included as defined by the description.

### DESCRIPTION OF PREFERRED EMBODIMENTS

In the following description, similar features in the drawings have been given similar reference numerals and in order to weight down the figures, some elements are not referred to in some figures if they were already identified in a precedent figure.

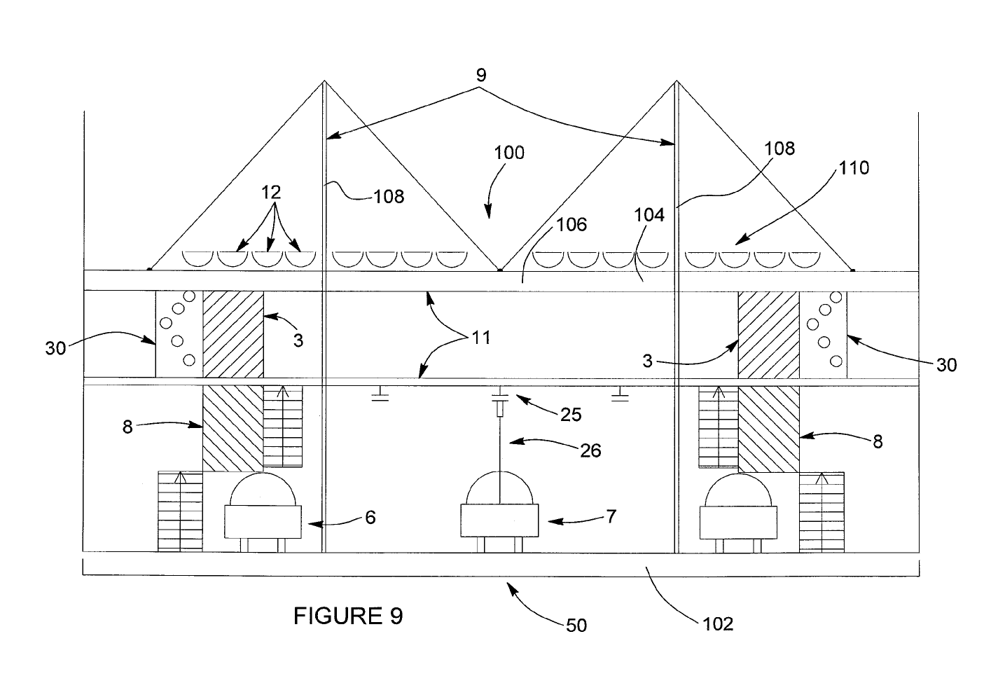

According to the present invention, as shown in FIG. 9, there is provided a vehicle propulsion energy and utility power delivery system 100 with a modular structure, the modular structure being installable over a roadway 102 and including a plurality of interconnectable modules 104. Each of the interconnectable modules 104 comprises a central platform member 106 extending over the roadway 102. The modules also include two lateral support members 108 on opposite sides of the central platform member 106 and a vehicle propulsion energy and utility power distribution system 110 positioned on the central platform member 106.

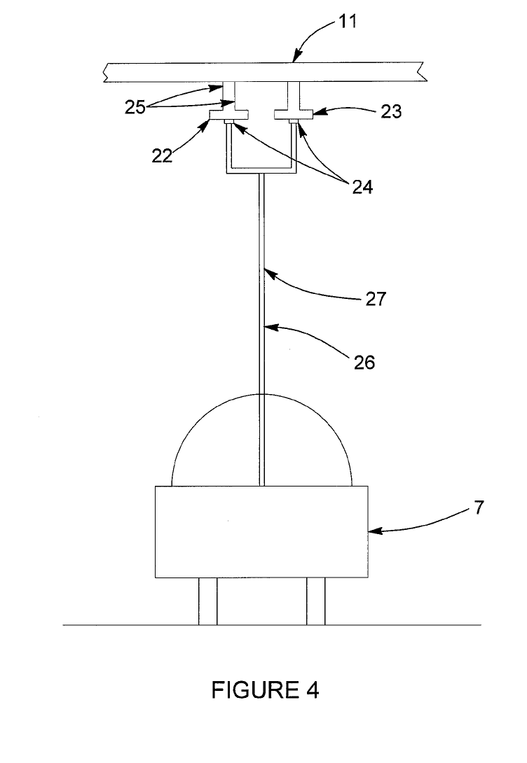

Preferably, the vehicle propulsion energy and utility power distribution system 110 comprises a two phase electrical bus, including a power bar 23 and a ground bar 22 as shown in FIG. 4, for distributing propulsion energy to vehicles operating under the central platform member through a friction type connection.

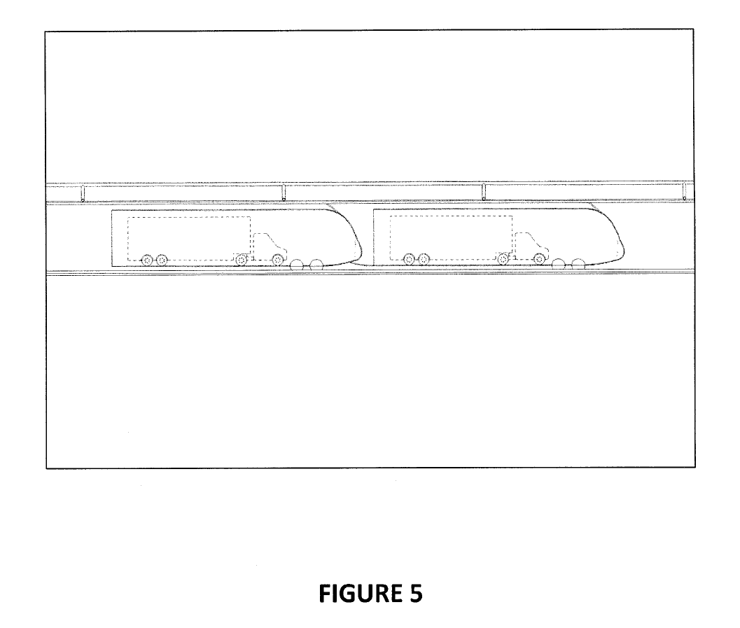

Preferably, as shown in FIG. 5, at least one of the vehicles is a transportation chariot 120.

Preferably, the central platform member comprises adjacent groupings of solar panels and roofing panels positioned along a length of the central platform member. The solar panels and roofing panels provide overhead protection of the roadway against outdoor weather elements.

Preferably, as shown in FIG. 5, the transportation chariot 120 is a motorised chariot comprising an aerodynamic wind screen 122 positioned on a front section of the chariot, and a vehicle accommodation subsystem adapted to carry at least one transportable vehicle 124 for displacement of the at least one transportable vehicle along the roadway.

Preferably, each of the interconnectable modules further comprises a plurality of pipes and cables supported by the central platform member and connected to the vehicle propulsion energy and utility power distribution system for providing above-ground utility services for buildings proximate the roadway.

### Innovative Solutions Envisioned

The installation, maintenance and operation of utility services is a large part of the monies and energies consumed for living and working. Almost all cities treat each utility and service independently and this has lead to the chaotic planning and the energy inefficient utilities and services that exist today. To improve the overall efficiency and particularly the energy efficiency of the buildings a new integrated thermal energy utility system is required for district heating and cooling. A new concept proposes an innovative and integrated design for installing a modular integrated support structure as part of this delivery system. As such the cost of the support structure is distributed between multiple services and not supported by any one utility or municipal service.

The electric motor is much more efficient than the internal combustion engine. If the electric motor is powered by renewable energy there are no emissions. Combating wind resistance then becomes the principal energy requirement followed by road resistance. If vehicles having a common frontal surface area can be advanced in a tunnel having the same dimensions as the vehicles, only the vehicle in the front is combating wind resistance. This greatly reduces the energy necessary to advance the second and following vehicles.

It is almost impossible to create such a tunnel and situation. However, it is possible to enclose vehicles in motorised wagons of similar dimensions that when aligned very closely, one behind the other, the wagons create the form of a semi-continuous tunnel. In this situation only the front container is facing wind resistance. We use the word chariot to describe these independently and electrically motorised wagons of similar dimensions.

Train travel has become popular as a more energy efficient means of transportation. One of the principal disadvantages of the train is the time lost waiting for the train to be assembled or loaded. The process of assembling a train is also called shunting. This implies placing the train cars on the track in a designated order for delivery.

This process requires many hours and the train cars must be loaded before shunting begins. Shunting yards are built using a series of separate track sidings and the operation is of the batch nature, one train at a time. A shipping container to be shipped by train may sit for hours or days before becoming part of a moving train.

Ideally trains could be assembled or shunted continuously from only two tracks. The train chariots on the main track are moving forward and train chariots moving along a second parallel track at the same speed are inserted into the moving train. In this new scenario, the train cars are loaded and shortly after enter onto the second track and begin accelerating to reach the speed of the train with which it will merge.

As train chariots approach their destination they separate from the moving train and merge back onto the second track. The front section of the train does not slow down and once the departing chariot has moved onto the second track the remaining chariots accelerate slightly to close up the gap left by the exited chariot. The exiting chariot then decelerates to a stop and its contents offloaded. This implies that each chariot is motorised and the preferred propulsion system is electrically driven.

The chariots offer a few standard shapes and are merged together so that similar shaped cars follow one another and as such travel in a semi-continuous tunnel. Only the front chariot of each series of similar chariots is incurring full wind resistance. The energy required to move a series of similar chariots decreases as their numbers increase.

For existing train passenger service, the departures may be infrequent as the train company plans the size and frequency of the trains to meet the customer demand. This same situation arises when passenger cars are part of the train shipment. Passengers can waste hours waiting to board a train or for it to leave. In the case of the chariot-train the automobile of the passengers is loaded onto one chariot and almost immediately it starts its journey. The chariot accelerates along the second track and merges with other chariots on the main track.

The cost of generating renewable wind power to replace existing non renewable sources, its visual impact, its environmental impact and the availability of the power distribution network are requirements requiring serious consideration. Existing horizontal axis wind turbines are large imposing structures. They present a risk for birds and generate a loud woof as the turbine blades pass in front of the tower mast.

The land on which they are built is often private and the cost of acquiring the permission to build becomes part of the cost of the power produced. The power is often produced in remote rural areas and the power distribution network to deliver the power to the end user does not exist. Ideally renewable power generation should be distributed and located as close to the end consumer as possible.

It has already been mentioned that the transportation sector is a large consumer of energy. Its conversion from the internal combustion engine to electric motor will lead to a huge new demand for electricity. Ideally new power generation should be located as close as possible to roadways to reduce distribution costs. The closest proximity would be on the roadway right-of-way. The site is publicly owned and not privately owned. Permission to build multiple units is negotiated with one level of government.

Electrical power production located on a right-of-way can be distributed directly to electrify the roadway underneath. The noise of the highway serves to mask the noise generated by a wind turbine. Given these advantages, wind farms will be located and configured to follow roadway right-of ways. This implies that the turbine mast or tower can be located along the roadway without blocking the existing traffic. Almost all existing windmills use a large diameter cylindrical mast which is unsuitable for this application. The solution is a platform with 4 or more thin legs that straddle the highway median or that can sit on lane dividers.

In addition, solar energy collection over roadways improves the safety of the roadway as rain and snow may be collected and sunlight glare on the road can be adjusted, the heat load for vehicle air conditioning is decreased and the quality of the environment increases. Similarly the generation of solar electricity requires large areas of land surface in order to collect the energy.

Placing solar collectors over roadway right-of ways eliminates the need to condemn other land surfaces and provides climatic protection for the road surface and vehicles using the road. Again the power generation is now distributed and supplied as close as possible to the end consumer, which in this case is the electric vehicle. For these justifications, solar collection farms are now located and configured to follow roadway right-of-ways.

Society has much catching up to do in order to replace its environmental footprint. New concepts to improve system efficiencies are a must if the planet is to survive the presence of mankind.

Seven new concepts will be presented involving the following areas:
A.1 electrification of a roadway with power from distributed wind turbines,
A.2 a retractable, friction-contact power connector and aerial power bar for supplying electric vehicles.
A.3 CSP panels for collecting thermal power and protecting roadway surfaces from the elements,
A.4 an electric continuous shunting train operating in a semi-continuous tunnel,
A.5 a modular aerial structure that integrates utility services, solar energy collection, and transportation services.
A.6 a modular, aerial, utility corridor that supports a plurality of utility, municipal and transportation services,
A.7 a road surface beam with a very uniform and smooth surface that reduces the energy consumed as rolling resistance between the road surface and the wheel or tire of vehicles.

Their integration will be illustrated in the context of four very common infrastructure developments:
B.1 a divided highway,
B.2 an urban artery,
B.3 an urban street,
B.4 a rural road.

### Enumeration of Targeted Utility, Municipal and Transportation Services

The community services that can be delivered aerially or with aerial support include energy, water and effluents, energy distribution, climate related services, communications, and some services provided indirectly such as protection of roadway surfaces from the elements and the potential fuelling of vehicles as they travel. Below is a list of services of which particular functions which can be integrated into one rack way type network supporting utilities and transportation.

### Services Related to Water and Effluent:

1) Collection of effluent and bio-degradable materials,
2) effluent treatment,
3) rain water collection and use,
4) drinking water treatment and distribution,
5) fire water distribution,
6) washing water treatment and distribution,
7) hot washing water treatment and distribution,

### Services Related to Climate

8) heating water distribution and return and cooling water distribution and return,
9) snow collection and melting along roadways,
10) rain and sun protection over roadways,
11) natural gas and biogas distribution,

### Solid Waste Collection Service

12) recycling receptacles and solid waste collection,

### Transportation Services

13) electrified roadways, electrified parking and parking fee collection,
14) electric bus service,
15) protected bicycle paths and bicycle parking,
16) elevated walk ways for pedestrian safety and improved traffic flow,
17) traffic lights and traffic flow management,
18) street lighting,
19) street and sidewalk cleaning,

### Electrical Power Distribution

20) distribution of electricity,

### Communication Services

21) telephone, cable, internet, security functions.

As already mentioned several times, the delivery of these 21 services are often planned 21 different ways by 21 different groups.

### New Concepts for Aerial Delivery of Services

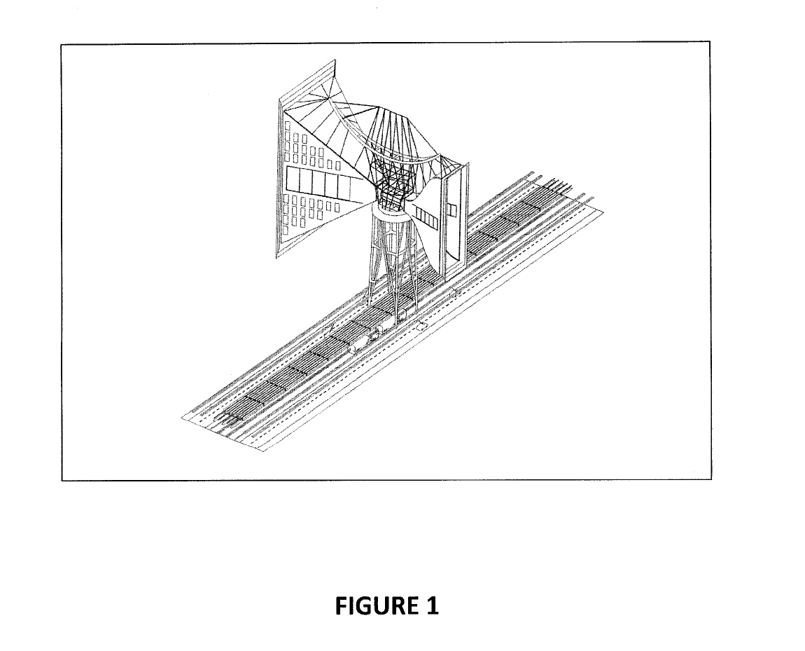

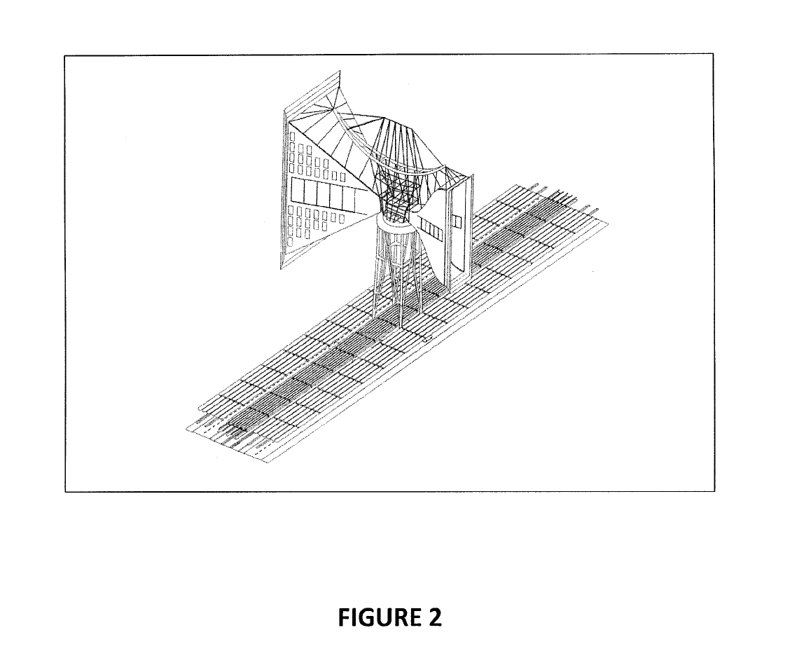

### A.1 (FIGS. 1 and 2) Use of Roadway Right-of-Way for Distributed Renewable Power Generation.

Wind turbines are installed on the right-of-way of existing expressways and divided highways and the area above the entire roadway can be used to support CSP modules. Multiple legs for the wind turbine and a support structure that avoids blocking traffic lanes is essential for an expensive implementation. The electricity produced is consumed by the vehicles passing underneath the wind turbines.

FIG. 1 illustrates a divided roadway of 4 highway lanes that includes a median mounted wind turbine and CSP modules that cover all traffic lanes as well as the median. The principal unique elements include:
a roadway right-of-way that serves for the foundations of the columns,
multiple tower legs that support the turbine platform,
wind turbine power distributed along the length of the roadway,
the power produced is diverted directly to electrify the roadway below saving the problems and expenses of power transmission.

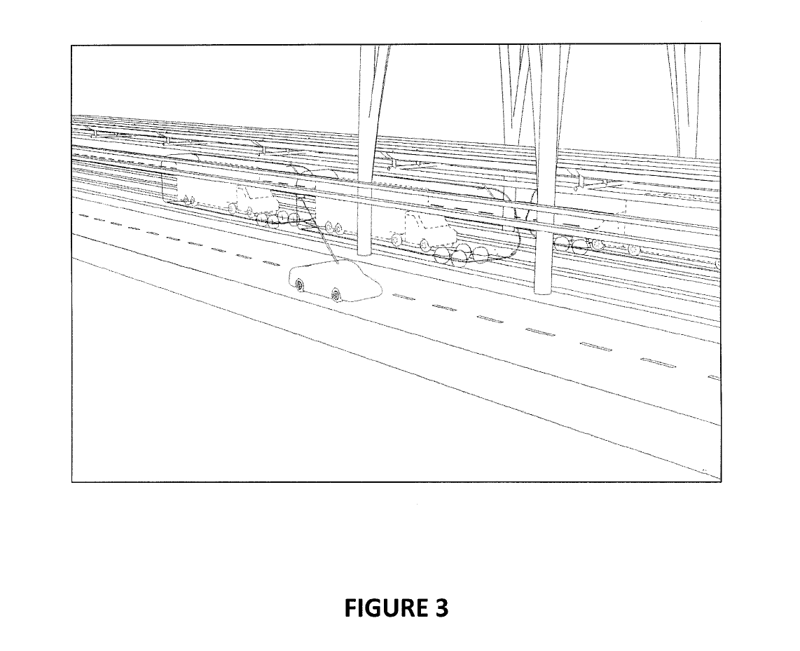

### A.2 (FIGS. 3 and 4) Electrified Roadway Power Distribution for Vehicles

Existing roadways are designed for vehicles using hydrocarbons as fuels. Hybrid vehicles have entered the marketplace but these vehicles all depend on hydrocarbons to extend the distance the car can travel before recharging the battery that provides propulsion. In some cities the electric trolley is used for mass transportation. However these vehicles do not use batteries but an electrified cable over the roadway supplies power to electric motors for propulsion. The attachment between the vehicle and the power line is fixed. Although the unwinding and rewinding of the power cable between the trolley-bus and the overhead power line permits some lateral movement these vehicles must follow a preset routing limited by the disposition of the overhead cables.

This arrangement for electrifying a roadway is not acceptable for an electric traffic vehicle requiring a long and flexible trajectory. As such, this design is not acceptable for electric vehicles including electric cars, trucks, buses and delivery vehicles.

A new roadway power system for delivering electrical power to electric vehicles is required that would allow them to charge the battery and feed the electric motors simultaneously while in transit. The entire roadway system does not need to be electrified as the vehicle battery can easily provide propulsion for short trips over non electrified roadways. This system will not limit the vehicle trajectories in the fashion experienced by existing electric trolleys and buses.

The intended system consists of two flat conducting surfaces running parallel to each over and located over the middle of each vehicle lane. The bars are electrically insulated from each other. One side is for power and the other side is the ground. Each vehicle is equipped with an telescopic rod that extends to touch the underside surface of the power and the ground plates.

Two rolling or sliding contact points are fixed to the end of the antenna and an insulated cable connects the contact points to the power and ground terminals of the electric motors and rechargeable battery. The actual point of contact is not a fixed connection but a friction connection as this will allow the points of contact to travel forward and/or sideways. In order to reduce friction and wear, the contact points may be establish through a rotating wheel or ski shaped blade with a treated surface or other device.

The distance between the two contact points is such that if the vehicle makes a lateral displacement the two contact points cannot be located on the same side of the power bar. One contact point will automatically loose contact with the face of the bar whereby avoiding a short circuit path between the power plates and the vehicle battery.

When the vehicle is located in the middle of a lane within a distance equal to the width of the power plates the vehicle is being fed electrically. Once the distance between the centerline of the vehicle exceeds the width of the power plates the vehicle runs on its battery. One or both of the contact points is no longer in contact with the power bar. The connecting rod is retractable to a lower non-extended position for access to indoor parking, car washes etc. For safety and to provide power for trucks and buses the overhead power plates are positioned out of reach for a person accessing a vehicle. In other words the power bar is located high enough to eliminate contact without a ladder. The power bar assembly may include a location positioning device that will automatically steer the vehicle to keep it in the middle of the lane. The electrified roadway and electric motor now replaces hydrocarbons and the internal combustion engine for automobile propulsion.

This change also decreases transportation costs and substantially decreases the cost of acquiring a car. The cost of an electric car is much cheaper to buy, drive and maintain than a hybrid or hydrocarbon powered vehicle. This system requires the installation of power bars above the clearance established for the roadway and as such a modular structure or rack way is a necessity for supporting the power bars.

FIG. 3 shows the disposition of an electric vehicle equipped with a retractable connecting rod, double pole friction contacts and a flat face aerial power bar. The general arrangement of a vehicle equipped with a retractable power antenna and associated equipment for use on an electrified roadway is depicted in FIG. 4.

The principal unique elements include:
two flat, electrically isolated surfaces running parallel to the road axis,
the surfaces are mounted aerially over the center of each traffic lane,
the surfaces are held in place on their back side to leave the surface facing the roadway unobstructed,
a telescopic connection rod extending up from the car,
two friction contact points at the end of the antenna rod that allows the points to remain in contact with the surface and displace in any direction over the face of the surfaces,
an insulated cable to connect the two contact points to the vehicle motors and battery.

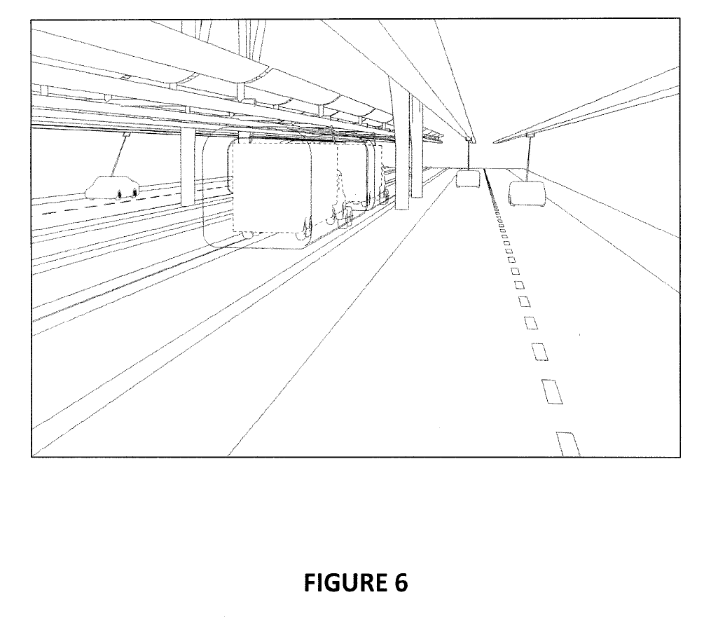

### A.3 (FIGS. 5 and 6) Electrified Train in a Semi-Continuous Tunnel

A chariot-train derives its name from the fact that independently powered chariots or motorised transportation platforms can be individually shunted to build a train based on the configuration or wind resistance of the chariots. Chariot trains are shunted or assembled while the chariots are in movement and are placed or inserted in the train to minimise the wind resistance as well as for grouping chariots for a common final destination. Chariot trains move vehicles, trailers or containers. It does not normally move bulk freight as this is the role of the existing freight train.

A chariot consists of a suspended platform, an electrically fed propulsion system and a wind deflector. The propulsion system is powered from an overhead power supply similar to that used by electric trains and trolleys. The propulsion system could be a set of motor-wheels or a maglev linear motor design. The chariot is built such that the vehicle to be transported can drive into it from the rear. If electric motor-wheels are used the power train is pneumatically loaded to increase traction with the ground and to reduce vibration.

Rather than use steel or rubber wheels the weight of the chariot and its load is preferably supported by a maglev system or possibly an air flotation system. As such, each lane consists of two parallel sets of flat surfaces that support the weight by magnetic field or air cushion. This does not mean that a rail system with steel or rubber wheels could not be used to support the weight of the loaded chariot. Maglev is simply the preferred system given its lack of maintenance and use of clean electrical power to support heavy loads.

Once a chariot has arrived at its final destination the vehicle simply backs off the platform and drives away under its own power. Another vehicle drives onto the maglev platform and it rejoins a new train on the track. The middle or additional lanes are used to accelerate the chariot up to the speed of the next appropriate approaching train and depending on the final destination requested it is inserted into the moving train.

For slowing down or stopping the motor-wheels at the front of all chariots provide regenerative braking. For an emergency stop while the train is in motion a friction plate located under each chariot is pressed against the ground surface of the lane between the two flat surfaces.

The chariot windshield covers the sides and top of the vehicle it is transporting. The back of the front chariot windshield fits up against or very close to the face of the windscreen of the chariot following it. The chariots can be coupled together magnetically while in motion to create a mini-train and to provide a semi-continuous temporary smooth tunnel shaped surface to the air. The temporary tunnel serves to minimize wind resistance and drag. The power for propulsion is then shared between the motors of the coupled chariots in each train.

Although no figure is yet available chariot trains should travel as fast as possible within the safety limits of the system. The higher the chariot-train speed the more important the reduction in wind resistance and drag and the greater the energy savings. The more chariots of the same outer dimension that travel together as a train, the less energy required by vehicle to travel.

A chariot-train line normally includes three or more lanes and the two outside tracks are for continuous one directional travel. The middle or additional lanes serve to enter or exit the two main traffic lanes without slowing down. The middle or additional lanes can also serve as a bypass in the event that sections of the main lines experience a problem. The general arrangement of a 2 unit chariot-train with a semi-continuous tunnel is depicted in FIGS. 5 and 6.

The principal unique elements include:
individually motorised chariots with rear access,
windscreen and walls around the chariot to minimise air resistance and this for several standard sizes of vehicle,
preferably electric propulsion using motor wheels,
preferably maglev or air flotation technology for supporting the weight of the platform and its load,
a three track system whereby one track is used to shunt or merge chariots while the train is in motion one of the two main lines. The merge is the middle lane and can merge chariots into either of the two main lines.

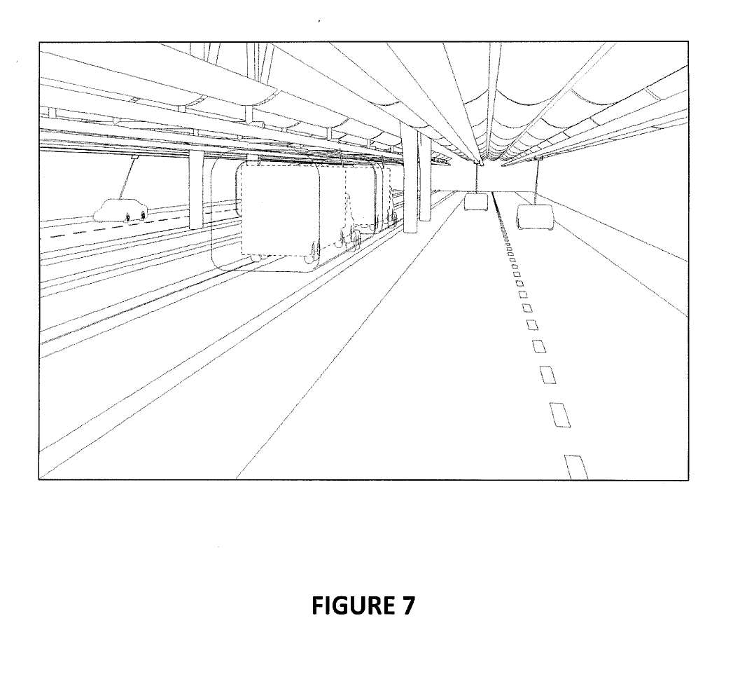

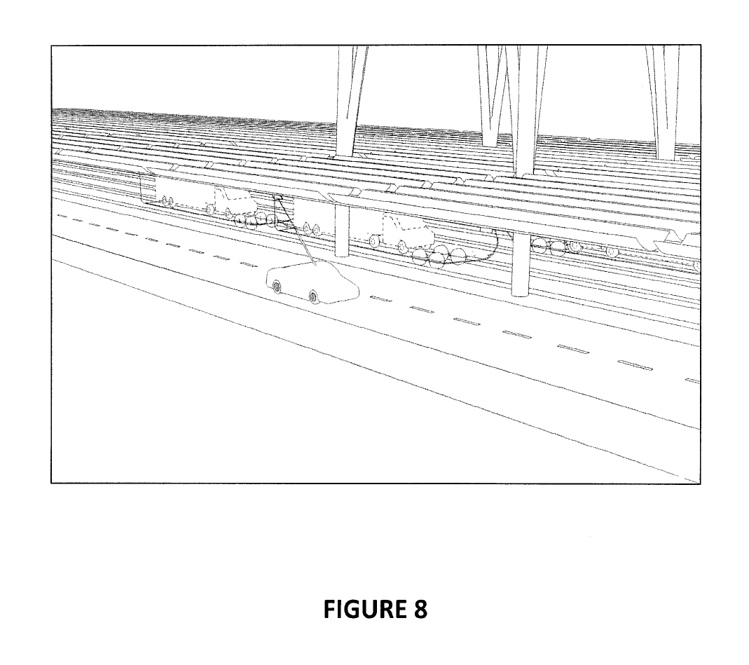

### A.4 (FIGS. 7 and 8) Solar Energy Collection Used to Provide Electricity and to Protect Roadways

Solar energy use to produce steam and drive electric turbines is in its infancy. Most solar energy used today produces low voltage electricity directly by photovoltaic cells or the suns energy is used to heat water. In order to produce steam of sufficient energy to drive a turbine the suns energy must be concentrated many times and two principal approaches are actually in commercial use.

In one approach, parabolic solar reflectors concentrate the sunlight on a pipe located along its focal point. In a second approach large reflecting surfaces can be used to reflect the suns energy onto a vessel that turns the suns concentrated energy into steam. These installations are normally located in sunny, arid climates and the sunshine striking many acres of land is concentrated onto the steam generator. The cost of the land is quite cheap and the number of hours of sunlight per year is maximized. Normally, there are no buildings or population close to the site of thermal solar steam generation.

One of the by-products of all thermal electrical power generation is waste heat in the form of low pressure steam. In order to increase the energy efficiency of the system the waste heat is used for the district heating of buildings. District heating has been used regularly in Europe for over a hundred years. Cheap energy prices in North America have resulted in low efficiency power generation facilities that do not include district heating. For thermal steam generation to supply district heating the power generation site must be close to the buildings to be served. Low pressure steam cannot be transmitted over long or medium distances.

CSP panels can absorb a very large part of the suns energy. They can be installed side by side to cover a large area. There are several advantages to installing them over roadways. They can prevent rain and snow from falling onto the road surface and can collect the rainfall or melting snow. By being located over road ways that are normally close to buildings where the water is needed. As such, the precipitation collected by CSP modules can be reused for building services and this replaces water from reservoirs.

CSP modules positioned over roadways can store the snow until it can be melted in place. By protecting the roadway from all types of precipitation the safety of the roadways increases substantially. At the same time in very sunny climates the roads and the automobiles are no longer directly in the sunlight. This reduces the air temperature in urban areas and increases the comfort for commuters.

Buildings and housing follow roadways. As such, the waste heat produced from thermal solar energy falling on road surfaces can often be used by nearby neighbouring buildings. In northern climates the heat is used for buildings and hot water, whereas in southern climates it is used only for hot water production. In both climates it may also provide low pressure steam for industry. In all instances where the heat collected is sufficient to drive a steam turbine, the steam turbine is of the backpressure type and the waste heat is distributed.

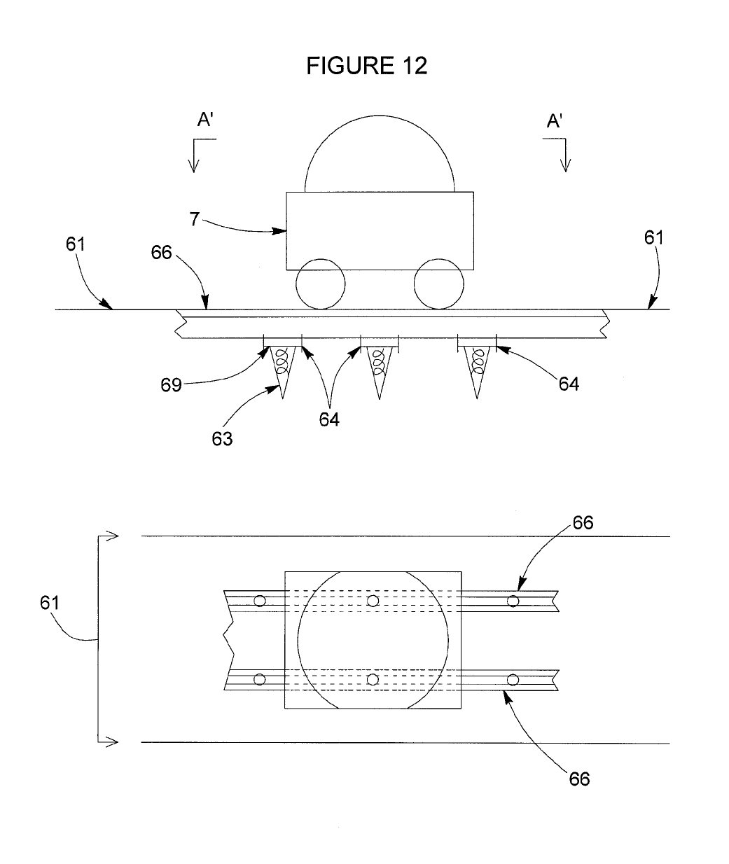

The CSP units sit on a frame over the road surface. This creates a roof that can capture the rainwater and snow. However an expansive, practical and aesthetically pleasing structure is required to support the frames that position the CSP units. In areas where blowing snow is common, the structure may have roll down walls. The walls roll down in conditions of blowing snow or high cross wind. Any snow that does get blown onto the road should be vacuumed and melted in place. A series of CSP modules installed over a roadway on a structure capable of supporting a plurality of services is depicted in FIGS. 7 and 12.

The principal unique elements include:
a frame that holds multiple CSP modules is suspended over a roadway right-of-way.
the frame sits on a modular, expansive structure that follows the roadway axis,
the CSP modules and frame create a continuous surface permitting that precipitation falling on the surface may be collected for reuse and that the precipitation does not reach the road surface.
   A.5 (FIG. 9) Integration of Utility Services, Solar Energy Collection, and Transportation Services Around a Modular, Expansive Structure Supported from a Roadway or Sidewalk Right-of-Way.

As discussed, the cost of installing the distribution network for new utilities and services will have a large impact on the economic feasibility of their implementation. In an effort to reduce the environmental impact of society and to conserve energy several new utility, municipal and transportation systems will be required. As examples, this will include district heating and cooling, additional power transmission for supplying energy for transportation, water recycling, power distribution for electric vehicles, piping systems for solar energy generation, bicycle paths to reduce urban traffic etc.

At the same time, many existing utility service distribution networks are obsolete and require replacement. The replacement of underground services is expensive and the constant excavation of trenches to repair or replace service lines leads to traffic problems. What is needed is a common structure that can accommodate a plurality of utility services of municipal services and of transportation services. As such, the cost of installing the structure is divided between several services and several categories of service.

The proposed structure will have a continuous axis parallel to the axis of the roadway, will straddle the roadway, will use repeating members placed at regular intervals, will be expansive (able to be extended indefinitely) and will provide a corridor the height of which will not be less than the minimum clearance established for the roadway. The structure will provide continuous or semi-continuous support of many or all services being delivered in the direction of the roadway. The structure will provide cross directional support for some of the services.

Depending upon the category of roadway being straddled, the size and width of the structure will vary according to the type and number of services involved. The number and type of services transported along a rural country road will differ to that of an urban artery. However, for all applications, the basic concept of a modular structure straddling the road surface that can be extended indefinitely remains.

The preferred material of construction of the structure is steel or laminated wood although columns could be in reinforced concrete. Laminated wood is an interesting option for its appearance and eco-friendly contribution to carbon dioxide emissions. Lightweight aluminium structures are unsuitable. The concrete foundations for the support structure are located along a roadway right-of-way and are positioned along an axis parallel to that of the roadway and can follow the roadway indefinitely. The vertical support members are preferably in steel and these members support the weight of all aerial utilities and transportation services.

The horizontal members are modular and designed according to the live and dead loads of the utilities and transportation services. In instances where the structure has more than one level of horizontal members an upper level is used to isolate pedestrian, bicycle or mass transportation from the vehicles traveling along the roadway. Horizontal members will support the equipment and power bars used to electrify the roadway for use by electric vehicles.

A mixture of collecting solar panels and transparent panels used to cover the roadway surface are mounted on a frame and this frame is supported by the vertical and horizontal structural members. The panels are situated above any electric power bars to protect them from precipitation.

The arrangement of a modular, expansive structure supported from a roadway or sidewalk right-of way is depicted in FIG. 9.

The principal unique elements include:
a plurality of utility, transport and municipal services are supported on a series of vertical columns or poles that are placed parallel to the axis of a roadway,
the columns are placed on both sides of large roadways and are opposite one another and their foundations are located on a roadway or sidewalk right-of-way,
the height of the first level of horizontal members is not lower than the clearance established for vehicles along the roadway,
the structure supports horizontal power bars located over the centerline of each lane of traffic and these bars supply electricity to vehicles using the roadway,
if the structure includes a second level, the vertical columns support certain transportation services provided at this level including pedestrian walkways, bicycle paths, and light bus service.
the structure may support a protection over all or part of the roadway surface consisting of a frame containing CSP modules,
the structure supports a utility raceway as defined in paragraph A.6 following.

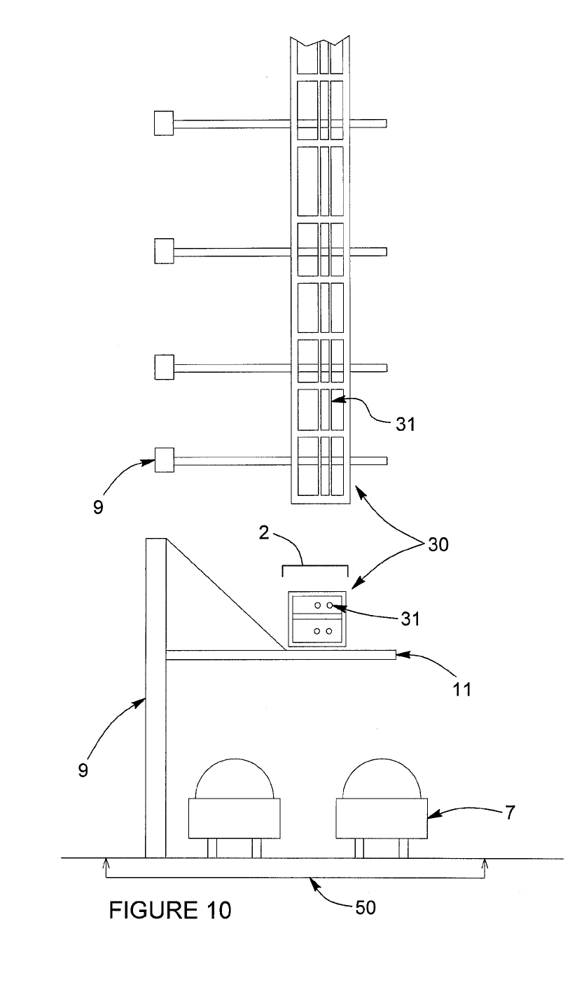

### A.6 (FIG. 10) Utilities Distribution Using a Utilities Corridor Supported by a Modular, Expansive, Roadway Structure

If a plurality of pipes and cables make up part of the services being distributed they are run in parallel, in proximity of one to another, in a set configuration. This section of the modular structure will be identified as a utility corridor as it is a space reserved expressly for that function. On urban arteries where the population density is high there will be a utility corridor for each side of the street to serve the buildings on each side.

For an urban street that has a lower population density than an artery, a centrally located utility corridor will serve buildings on both sides of the street.

The pipes and cables of a plurality of utility services are supported by a separate raceway which is in turn supported by horizontal structural members. The raceway is designed to provide sufficient support for all cables, pipes and freeze protection.

The arrangement of a utilities corridor in an aerial structure for a plurality of services is depicted in FIG. 10.

The principal unique elements include:
a plurality of utility or municipal services are supported aerially, parallel to one another and parallel to the axis of the roadway they follow,
the utilities are supported by horizontal and vertical members that constitute a dedicated utilities corridor that is supported by a modular, expansive structure as defined in A.5
a utilities corridor may serve the buildings on one or both sides of the street.

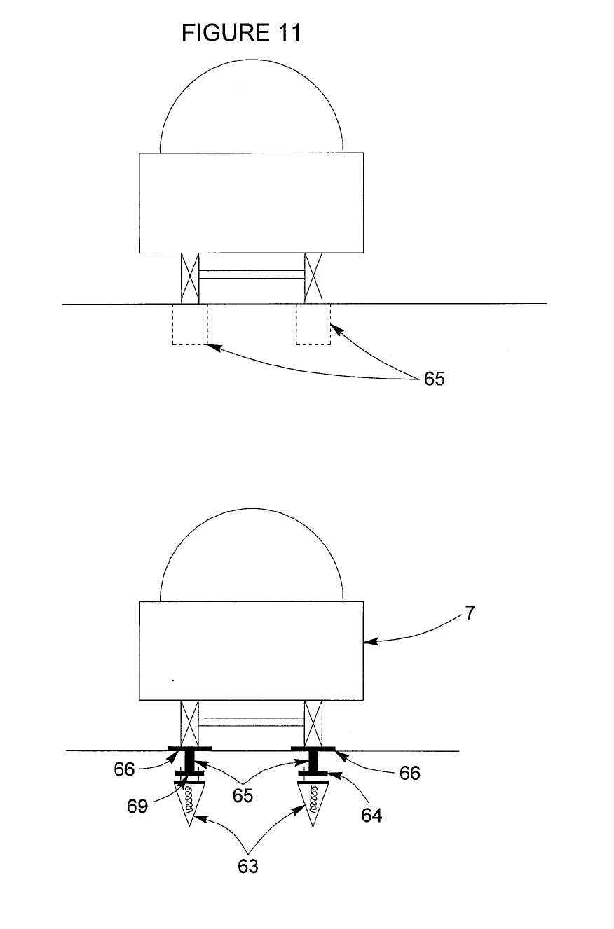

### A.7 (FIGS. 11 and 12) Modular Expansive Surface Beams for Roadways

The intent is to provide a very smooth and level surface for the wheels of the vehicles to roll on. Each lane of traffic receives two road inserts placed along the track followed by vehicles traveling along the center of the lane. The width of the insert is slightly larger than the width of the tires of the vehicles using the roadway. If the roadway exists, two trenches are cut in the roadway surface and screw type piles are inserted into the roadway bed until the pile cap is at the appropriate level to support the beams. The piles serve to support the beams, to establish a uniform height and to keep the beams from heaving. Screw type piles are preferred as they can be tuned into the ground to establish the height of the inserts.

The diameters of the heads of the piles are always smaller than the width of the beam plate surface. Two vertical skirts may be attached to the edges of the plate to obtain more strength against deflection and to support the road edges created by the excavation. However, the piles could be fabricated by standard cylindrical forms inserted into the roadway and filled with reinforcing steel and concrete. What is important is the pile caps establish a very uniform height for anchoring the beams.

The beams are structural in that they support the weight of the vehicles and the weight is transferred to the pile caps. The beams may be made of reinforced concrete, steel or other strong materials. The upper face has a width slightly larger than that of the largest vehicle tires. The profile of the beam is such that there is a middle rib to supply compressive strength and a lower base plate that serves as a connection to the face of the pile caps.

The beam is placed so that the surface facing the wheels is slightly above the nominal road surface. If the surface where lower than the road surface water could collect and cause a driving safety problem.

The road surface beams can also serve to direct the steering of the vehicle and keep the tires centered on the insert. On or close to the edge of each beam facing the middle of the lane, a signal cable or metallic strip is installed. These serve to be able to locate the position of the edge of the beam. This may also be achieved by identifying the line between magnetic material (the beam) and non magnetic material (the roadway surface). One or several signal receptors are located on the front vehicle axle in the area of the disc brakes.

A controller located on the vehicle will steer the wheels in order to follow the center line of the beams. Whereas a cruise control helps the control the vehicle speed, the beams inserted into the roadway will assist the driver in keeping the vehicle positioned visually in the middle of the lane or by a measured signal generated by the beam structure.

The arrangement of a modular, expansive road surface beam for a roadway is depicted in FIGS. 11 and 12.

The principal unique elements include:
an existing roadway surface that is partially excavated to a width and height slightly larger than the beam dimensions,
a beam possessing a flat smooth surface slightly larger than the width of the tires of the vehicles is installed slightly higher than the nominal height of the road surface,
the beam includes a middle rib section and lower under plate,
the under plate of the beam is attached to a pile cap below the road surface.
adjusting bolts and a vibration pad are located on the top of the pile cap to adjust the height of the beam.

### B) Establishing Models for the Integration of a Plurality of Services and Sectors

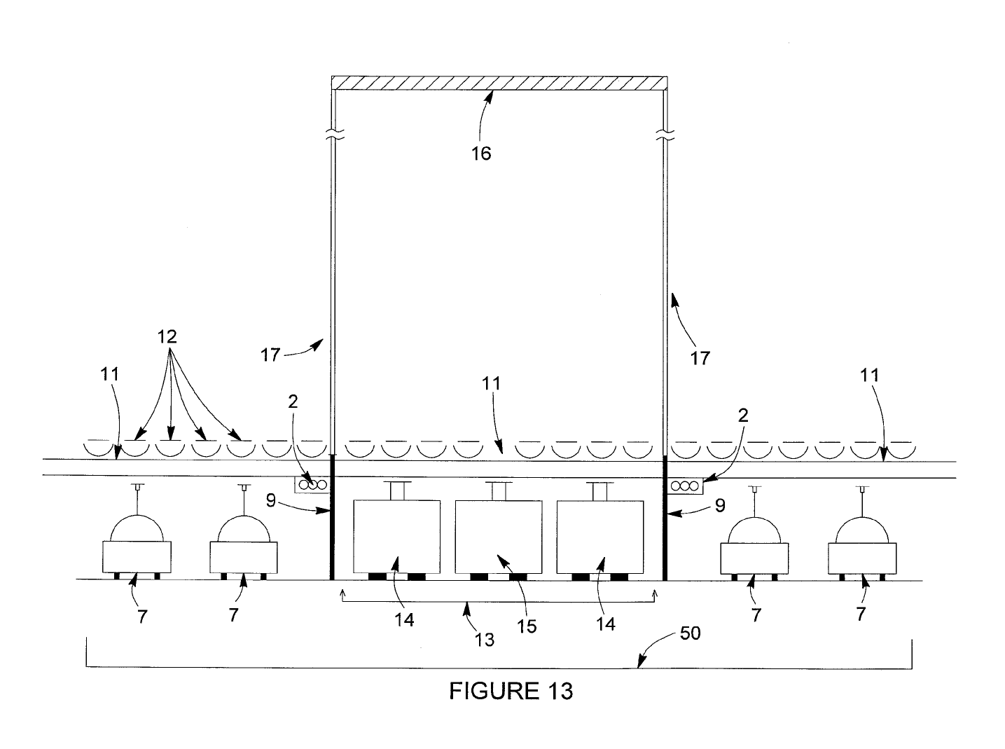

### B.1 (FIG. 13) The Highway Model

The highway or divided highway connects urban centers and carries large volumes of vehicular and truck traffic. Highways are normally located outside urban areas whereby the number of utilities transported is reduced and those that are transported do so in large quantities. The median section is often a landscaped depression to improve drainage and to reduce the possibility of head on collisions.

In winter months and during rainstorms the surface becomes slippery and spectacular accidents are commonplace. Sun glare, rain, and snow are often cited as the cause of the road accident. Highway transportation using hydrocarbons as fuel for vehicles is a major contributor to greenhouse gas emissions.

The modular aerial utility structure proposed can support a plurality of services. It can provide overhead power for the electrification of the existing traffic lanes. It can also support electrification infrastructure for electric train and/or chariot-train services. CSP panels can be supported over the entire roadway surface. This new protection captures all precipitation so that it can be reused and provides the necessary support for intelligent low energy lighting of the road surface. By the keeping the road surface dry the safety of the roadway is vastly improved.

A utility corridor can be established above the roadway to move utility services such as natural gas, compressed bio gas, electrical power and communication cables. The piping required to collect steam generated by the solar panels is also supported by the modular structure. Existing road sign structures are removed and the sign panels are supported by the modular structure. A typical arrangement of the proposed new aerial support structure is shown in FIG. 13.

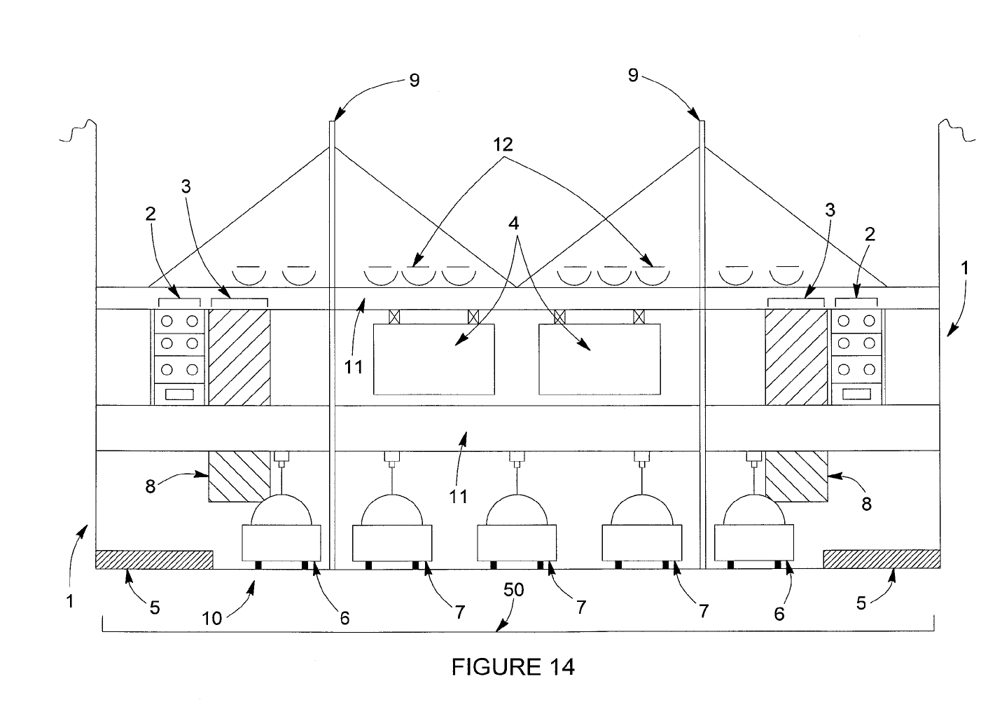

### B.2 (FIG. 14) The Urban Traffic Artery Model

The urban artery carries the most utility and transportation services as it covers the territory with the highest population density. The need is for vehicular traffic, mass transportation as well as bicycle and pedestrian traffic. In order to accommodate all these transportation needs the modular structure now has two or more levels. The upper level is reserved for mass transportation, bicycle paths and the utilities corridor.

The entire roadway may be covered by CSP solar panels or transparent panels. As the production of solar steam is now situated in a densely populated area there is a need for a delivery system for district heating. All existing district heating systems use an underground delivery system. The design of the new aerial structure now makes it much cheaper to deliver this service aerially.

The advantage of integrating into the modular structure a support necessary for the roof greatly improves the security of the road surface and sidewalks. Walking and bicycling are not presently dependable means of transportation as snow rain and inclement weather limit their availability. Bicycles and pedestrians sharing the same surface as vehicles is a very unsafe practice. The modular structure provides the support necessary to create designated pathways for pedestrians and bicycles independent of vehicle traffic.

Automobile pollution is a serious problem in cities. The modular structure supports electrification of both vehicle and mass transportation. A typical arrangement of the modular structure adapted to the urban artery is shown in FIG. 14.

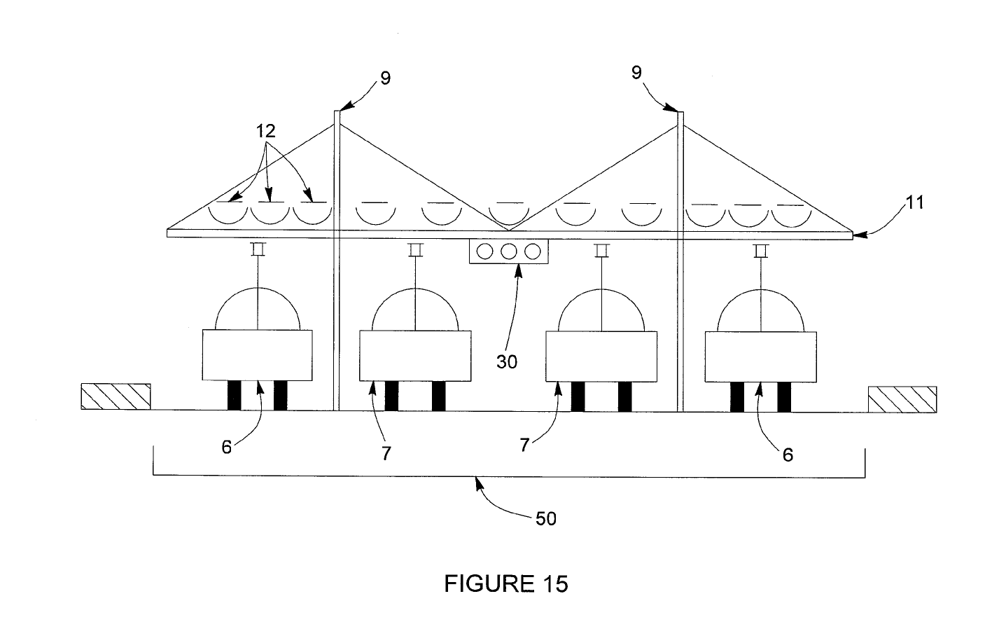

### B.3 (FIG. 15) The Residential Street Model

The residential street delivers a mixture of utility and transportation systems that resembles the urban artery but with certain differences due to the reduced population density. The public transportation load is lower and is delivered by a road bus. Decreased traffic allows bicycles and pedestrians to share the same roadway with less danger of accidents. The utility corridor now serves the buildings on both sides of the street. A typical arrangement of the modular structure for a street application is shown in FIG. 15.

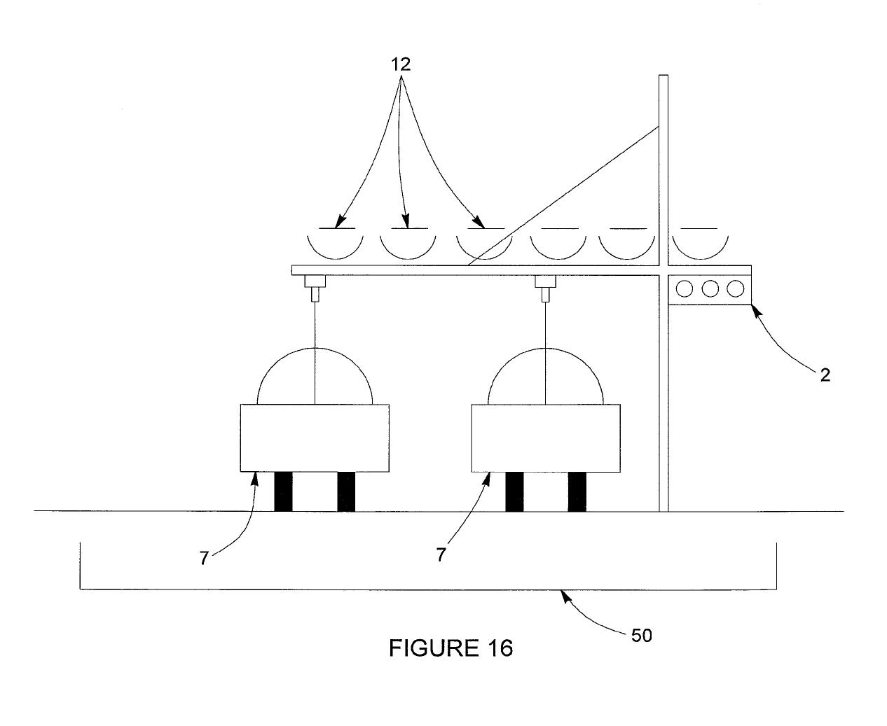

### B.4 (FIG. 16) The Low Density Rural Road Model

The rural road has a much decreased traffic load but the electrification of the roadway is still a need. Rural areas generate much organic waste that can support bio gas production. Houses are equipped with wells and septic tanks which diminish the utility type services provided and public transportation id limited to school buses. However a low cost modular structure may make the addition of these services less costly.

The treatment of organic material for biogas production requires a lot of thermal energy. As such a district heating distribution system may be economically feasible following the implementation of aerially delivered services. A typical arrangement of the modular structure for a rural road application is shown in FIG. 16.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1-6. (canceled)

7. A vehicle propulsion energy and utility power delivery system with a modular structure, said modular structure being installable over a roadway and including a plurality of interconnectable modules, each of said interconnectable modules comprising:
a central platform member extending over the roadway;
two lateral support members on opposite sides of the central platform member; and
a vehicle propulsion energy and utility power distribution system positioned on the central platform member.

8. The vehicle propulsion energy and utility power delivery system according to claim 7, wherein the vehicle propulsion energy and utility power distribution system comprises a two phase electrical bus for distributing propulsion energy to vehicles operating under the central platform member through a friction type connection.

9. The vehicle propulsion energy and utility power delivery system according to claim 8, wherein at least one of the vehicles is a transportation chariot.

10. The vehicle propulsion energy and utility power delivery system according to claim 7, wherein the central platform member comprises adjacent groupings of solar panels and roofing panels positioned along a length of the central platform member, said solar panels and roofing panels providing overhead protection of the roadway against outdoor weather elements.

11. The vehicle propulsion energy and utility power delivery system according to claim 8, wherein the central platform member comprises adjacent groupings of solar panels and roofing panels positioned along a length of the central platform member, said solar panels and roofing panels providing overhead protection of the roadway against outdoor weather elements.

12. The vehicle propulsion energy and utility power delivery system according to claim 9, wherein the central platform member comprises adjacent groupings of solar panels and roofing panels positioned along a length of the central platform member, said solar panels and roofing panels providing overhead protection of the roadway against outdoor weather elements.

13. The vehicle propulsion energy and utility power delivery system according to claim 9, wherein the transportation chariot is a motorised chariot comprising:
an aerodynamic wind screen positioned on a front section of the chariot; and
a vehicle accommodation subsystem adapted to carry at least one transportable vehicle for displacement of the at least one transportable vehicle along the roadway.

14. The vehicle propulsion energy and utility power delivery system according to claim 7, wherein each of the interconnectable modules further comprises:
a plurality of pipes and cables supported by the central platform member and connected to the vehicle propulsion energy and utility power distribution system for providing above-ground utility services for buildings proximate the roadway.

15. The vehicle propulsion energy and utility power delivery system according to claim 8, wherein each of the interconnectable modules further comprises:
a plurality of pipes and cables supported by the central platform member and connected to the vehicle propulsion energy and utility power distribution system for providing above-ground utility services for buildings proximate the roadway.

16. The vehicle propulsion energy and utility power delivery system according to claim 9, wherein each of the interconnectable modules further comprises:
a plurality of pipes and cables supported by the central platform member and connected to the vehicle propulsion energy and utility power distribution system for providing above-ground utility services for buildings proximate the roadway.

17. The vehicle propulsion energy and utility power delivery system according to claim 10, wherein each of the interconnectable modules further comprises:
a plurality of pipes and cables supported by the central platform member and connected to the vehicle propulsion energy and utility power distribution system for providing above-ground utility services for buildings proximate the roadway.

18. The vehicle propulsion energy and utility power delivery system according to claim 11, wherein each of the interconnectable modules further comprises:
a plurality of pipes and cables supported by the central platform member and connected to the vehicle propulsion energy and utility power distribution system for providing above-ground utility services for buildings proximate the roadway.

19. The vehicle propulsion energy and utility power delivery system according to claim 12, wherein each of the interconnectable modules further comprises:
a plurality of pipes and cables supported by the central platform member and connected to the vehicle propulsion energy and utility power distribution system for providing above-ground utility services for buildings proximate the roadway.

20. The vehicle propulsion energy and utility power delivery system according to claim 13, wherein each of the interconnectable modules further comprises:
a plurality of pipes and cables supported by the central platform member and connected to the vehicle propulsion energy and utility power distribution system for providing above-ground utility services for buildings proximate the roadway.
